(19) United States
(12) Patent Application Publication
(10) Pub. No.: US 2015/0123758 A1
(43) Pub. Date: May 7, 2015

(54) TRANSFORMER WITH FORCE ABSORBING ELECTRICAL INSULATION

(71) Applicant: Hammond Power Solutions, Inc., Guelph (CA)

(72) Inventor: Dhiru S. Patel, Guelph (CA)

(73) Assignee: Hammond Power Solutions, Inc., Guelph (CA)

(21) Appl. No.: 14/069,935

(22) Filed: Nov. 1, 2013

(51) Int. Cl. H01F 27/32

(52) U.S. Cl. CPC H01F 27/324
USPC 336/198

(57) ABSTRACT

A transformer includes a core of magnetic permeable material around which both a primary coil and a secondary coil extend. A sheets of electrical insulation are located between the layers of windings of the primary and secondary coils, between the primary and secondary coils, and between the core and the coils. The sheet is formed of material that is non-conductive to electricity, and has a first major surface and a second major surface opposing each other. A first plurality of ribs projects outward from the first major surface. Optionally a second plurality of ribs projects outward from the second major surface of the sheet. The force exerted on to the inter-layer or inter-winding electrical insulation sheets during the winding process are absorbed by deformation of one or more of the ribs thereby inhibiting that force from adversely affecting the electrical insulating property of the sheet.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to electrical transformers, and more particularly to electrical insulation used in the transformers.

2. Description of the Related Art

Transformers are conventional electrical devices for converting alternating electricity at a first voltage level to a second voltage level. The second voltage level may be greater or lesser than the first voltage level. A transformer has a primary coil of wire that is inductively coupled to a secondary coil of wire. To enhance the inductive coupling, the primary and secondary coils are often wound around a core of very high magnetic permeability, for example iron cores are usually used. The alternating input voltage is applied to the primary coil which generates an electromagnetic field that is coupled through the core to the secondary coil. That coupling induces alternating voltage in the secondary coil, thereby producing the output current from the transformer when a load is connected.

Because the core also is electrically conductive, electrical insulating material is frequently placed between the core and each coil. In addition, electrical insulation is used at places where the primary and secondary coils contact each other and between adjacent layers of wire in the same coil. For example, a sheet of electrical insulating material can be wrapped around the component, such as the core or coil, to be isolated electrically from an abutting component.

For thermal reasons and cost effectiveness, it is desirable that the thickness of the insulation be as small as possible. The surface of a wire layer of round or rectangular conductors is uneven. Sheet or foil conductors may have burrs on their edges. Thus force exerted on an insulation sheet during the winding process can cause the coil to puncture or otherwise damage the insulation and provide an electrical path through the insulation sheet. Such electrical paths defeat the ability of that sheet to electrically isolate conductive elements and cause the transformer to fail when electrically energized.

The insulation sheets are commonly produced from fibrous material, such a paper pulp, by repeated pressing a body of pulp through successive pairs of smooth rollers with decreasing gaps between the rollers of each pair. The resultant sheet has two smooth, opposing major surfaces. This process, called “calendaring”, reduces thickness of the paper and at the same time provides a non-porous, homogeneous mass having increased mechanical strength. Nevertheless, many commercially available insulation sheets, that are thin enough for practical use in transformers, do not possess adequate mechanical strength to withstand the forces applied during coil winding and assembly processes.

Therefore, there still is a desire to provide a relatively thin sheet of electrical insulating material that is able to withstand the forces exerted on the sheet during transformer manufacturing.

### SUMMARY OF THE INVENTION

A transformer includes a core of magnetic permeable material around which both a first coil and a second coil extend. A sheet of electrical insulation is located either between the first coil and the core or between the first and second coil.

The sheet is formed of material that is non-conductive to electricity, and has a first major surface and a second major surface opposing each other. A first plurality of ribs projects outward from the first major surface. The first plurality of ribs may be parallel to each other and may be spaced at regular intervals, however, other orientations can be used. The first plurality of ribs may extend perpendicular to an edge of the first major surface or may extend at an acute angle to the edge.

The force exerted on to the inter-layer or inter-winding electrical insulation sheets during the winding process are absorbed by deformation of one or more of the ribs, thereby inhibiting that force from affecting the electrical insulating property of the sheet.

In another embodiment, a second plurality of ribs projects outwards from the first major surface intersecting the first plurality of ribs. In one variation, the first plurality of ribs are perpendicular to one edge of the sheet and the second plurality of ribs are perpendicular to other edge. In a different variation the first and second pluralities of ribs extend at acute angles to an edge of the sheet.

In a further embodiment of the basic concept, a second plurality of ribs projects outward from the second major surface of the sheet.

### BRIEF DESCRIPTION OF THE DRAWINGS

FIG. 1 is a perspective view of a transformer that incorporates electrical insulation according to the present invention;

FIG. 2 is a cross sectional view through the transformer along line 2-2 in FIG. 1;

FIG. 3 is a perspective view of a major surface of a first sheet of electrical insulation, wherein that surface has a plurality of parallel ribs extending across the width of the sheet;

FIG. 4 is a perspective view of the opposite major surface the first sheet in FIG. 1;

FIG. 5 is partial cross sectional view of a portion of the transformer between a core and one coil;

FIG. 6 is a perspective view of an apparatus for manufacturing the first sheet of electrical insulation;

FIG. 7 is a perspective view of the opposite major surface of a second sheet of electrical insulation that has parallel ribs on both major surfaces;

FIG. 8 is a perspective view of a third sheet of electrical insulation in which a plurality of parallel ribs extend lengthwise;

FIG. 9 is a perspective view of a fourth sheet of electrical insulation having parallel ribs extending diagonally across the sheet;

FIG. 10 is a perspective view of a fifth sheet of electrical insulation having a two sets of diagonally extending ribs that intersect each other;

FIG. 11 is a perspective view of a sixth sheet of electrical insulation having a two sets of parallel ribs that extend orthogonally to each other; and

FIG. 12 is a perspective view of a major surface of a seventh sheet of electrical insulation in which the ribs are formed by fibers bonded to that surface.

### DETAILED DESCRIPTION OF THE INVENTION

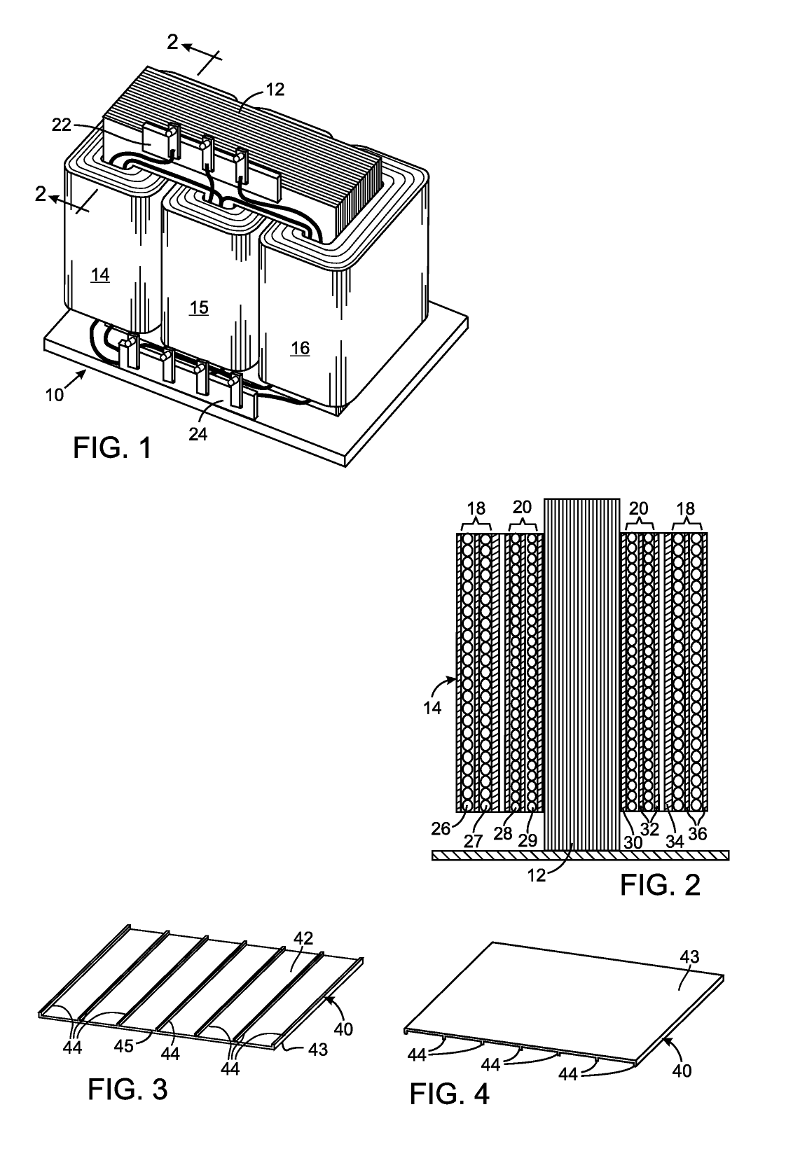

Referring initially to FIGS. 1 and 2, a three-phase transformer 10 includes a magnetic core 12 that has separate legs around which three coil assemblies 14, 15 and 16 are wound. The core 12 is formed from material having a relatively high magnetic permeability, such as a ferromagnetic material, so that the individual first and second coils 14 and 16 with each coil assembly 14-16 are inductively coupled through core. As shown in FIG. 2, for example, a first coil 18 of the first coil assembly 14 may serve as a primary coil and the associated second coil 20 may function as a secondary coil. The first coil 18 in each assembly 14-16 may have multiple taps one of which is connected to a set of primary terminals 22. The second coil 20 in each assembly 14-16 is connected to a second set of terminals 24.

With particular reference to FIG. 2 showing the details of the first coil assembly 14, the inner second coil 20 comprises an electrical conductor, such as a wire or foil strip, for example, wound around the core 12 in a plurality of winding layers. The outer, first coil 18 comprises another electrical conductor wound around the inner, second coil 20, and thus also around the core 12 in another plurality of winding layers. An first electrical insulator 30, in the form of a sheet of electric insulating material, is wrapped around the core 12 separating the core from the second coil 20. A second electrical insulator 32, in the form of another sheet of electric insulating material, is wrapped between the layers of the windings of the second coil 20. Another sheet of electric insulating material, provides a third electrical insulator 34 that extends between the first and second coils 18 and 20. A fourth electrical insulator 36 comprises a further sheet of electric insulating material wrapped between the layers of the windings of the first coil 18. The second and third coil assemblies 15 and 16 have the same configuration as the first coil assembly 14 just described.

Electrical insulators 30-36 are fabricated from material that is non-conductive to electricity, such as wood pulp to form a sheet of standard insulating paper. Other electrical insulating materials can be used. One such other insulating material is an aromatic polyamide polymer, for example, the Nomex® brand produced by E. I. du Pont de Nemours and Company.

The four electrical insulators 30-36 are uniquely designed. Each insulator comprises a sheet having a plurality of compressible ribs on at least one surface that cushion forces applied to the sheet during manufacture of the transformer 10. When the first and second coils 18 and 20 are cast into a resin material, the ribs also allow resin to flow through between the conductors of the coils. Compression of the ribs also exerts radial forces on the associated coil that tends to prevent the electrical conductor from sliding axially along the core. This eliminates a need to provide support beneath each coil.

A first sheet 40 of insulation, shown in FIGS. 3 and 4, has a first major surface 42 on one side and an opposing major surface 43 on the opposite side. A plurality of ribs 44 project outward from the first major surface 42. Those ribs 44 extend across the entire width of the first sheet 40 perpendicular to a lengthwise edge 45 of the sheet. The plurality of ribs 44 are spaced at regular intervals, however, irregular intervals can be employed. Although the ribs 44 have a rectangular or square cross section, ribs with other shapes can be used. The second major surface 43 of the first sheet 40 is smooth and void of the ribs.

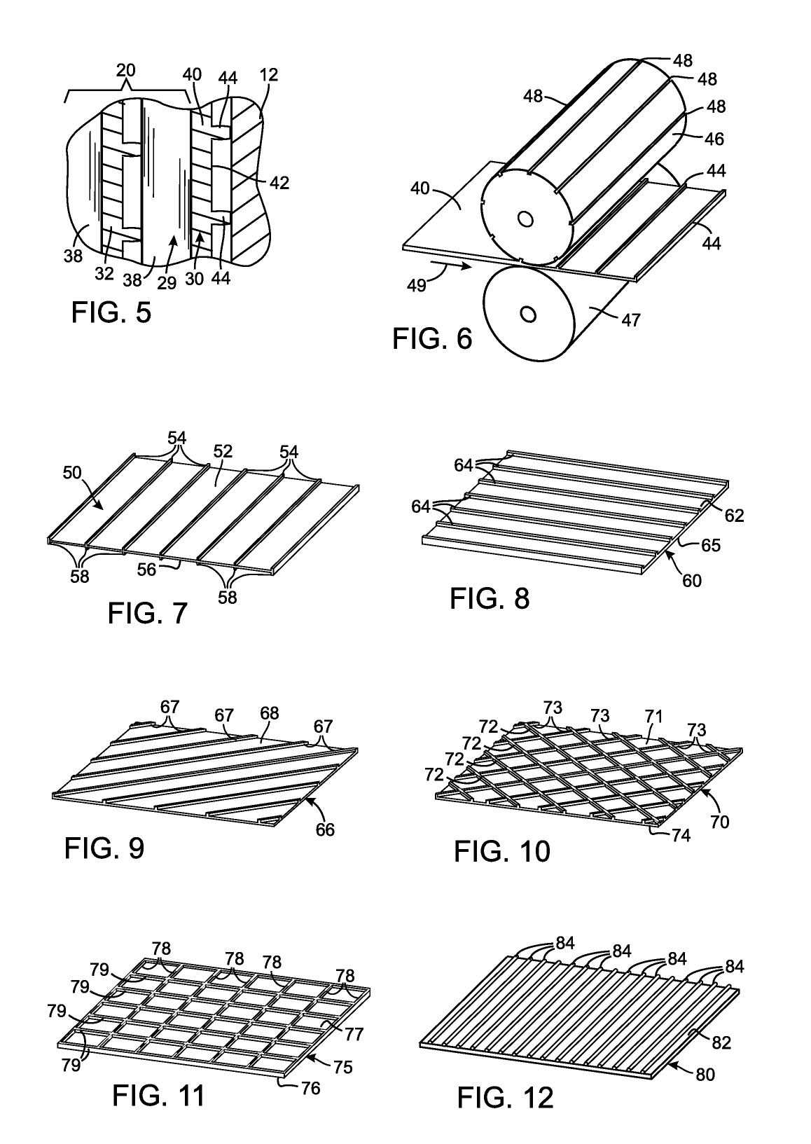

When the first sheet 40 is used as the first electrical insulator 30 in FIG. 2, the sheet is wrapped with the ribs abutting the core 12, thereby maintaining the first major surface 42 of the sheet spaced slightly away from the core as seen in FIG. 5. Thereafter, as the electrical conductor 38 of the second coil 20 are wound around the core 12 and the first insulation sheet 40 thereon, force exerted by the winding process tends to deform the resilient ribs 44, e.g. cause the ribs to bulge, thereby acting as a cushion to absorb that force. Therefore, the force from the coil conductors or their uneven edges will be dispersed and not tend to puncture or otherwise damage the insulating sheet and the ability of that sheet to electrically isolate adjacent components.

When used as the second insulator 32, the first sheet 40 is wrapped with ribs 44 against the inner layer of windings 29 in the second coil 20 and oriented transverse to the direction in which the coil conductors are wound. In other words, each rib 44 extends across several conductors of the second coil 20. As a result of that orientation, as the outer windings layer 28 of the second coil 20 wound around the first layer 29, the forces exerted by the winding process are transferred to and absorbed by the ribs, thereby mitigating the possibility of damage to the insulating property of the second insulator 32. The third and fourth insulators 34 and 36 are similarly oriented with their ribs 44 extending across several conductors.

It should be understood that the length and width dimensions of the first sheet 40, their proportional relationship, and the number of ribs 44 as shown in the accompanying drawings can vary depending upon the size of the insulating sheet required in a particular transformer. For example, the length of the sheet used for the first insulator 30 around the transformer core 12 in FIG. 2 is shorter than length of the sheet used for the third insulator 34, because the third insulator extends around the outer surface of the first coil 18.

FIG. 6 depicts a calendaring apparatus for producing the insulating sheet 40 with a plurality of ribs 44 on one side. A pair of rollers 46 and 47 is provided with a pattern of grooves 48 formed on the circumferential surface of the first roller 46. The grooves 48 correspond in size, shape, and spacing to the desired configuration of the ribs 44 to be formed on the sheet 40. The raw sheet of the material that has generally flat upper and lower surfaces is fed between the rollers 46 and 47 in the direction indicated by arrow 49. As the raw sheet passes between the rollers, the small inter-roller gap causes the material to be compressed into a thinner sheet and forces some of the material into the grooves in the first roller 46, thus producing the ribs 44 in the finished sheet. Although a discrete sheet of raw material is shown being fed through rollers 46 and 47, the calendaring can be applied to material fed from a large roll which is thereafter cut into desired size sheets.

FIG. 7 illustrates a second embodiment of an insulating sheet 50 according to the present invention. The second sheet 50 has a first major surface 52 with a first plurality of ribs 54 extending across the width of the sheet. The opposing second major surface 56 of the sheet 50 has a second plurality of ribs 58 also extending across the width of the sheet registered with the first plurality of ribs. Although each pair of a first rib and a second rib is in registration, i.e. lay in a common plane that is perpendicular to the major surfaces 52 and 56, the ribs on one major surface can be offset from the ribs on the other major surface. The second sheet 50 with ribs on both surfaces can be produced by a calendaring process similar to that shown in FIG. 6, wherein the second roller 47 has a pattern of grooves identical to grooves 48 of the first roller 46.

FIG. 8 shows a third sheet 60 of insulating material according to the present invention, in which the first major surface 62 has a plurality of ribs 64 extending lengthwise. In particular, these ribs extend perpendicular to a widthwise edge of the third sheet 60. The calendaring apparatus to produce this sheet has one roller with annular grooves around its curved outer surface to produce the grooves running lengthwise. The opposing major surface 65 of the third sheet 60 optionally may have a second plurality of ribs extending either lengthwise or widthwise.

With reference to FIG. 9, a fourth insulating sheet 66 has a plurality of diagonally oriented ribs 67 on a first major surface 68. In other words, the ribs 67 extend at acute angles to the edges of the first major surface. The opposing second major surface of the fourth insulating sheet 66 can also have a second plurality of ribs thereon, which are either aligned with or transverse to the first plurality of ribs 67. For a diagonal rib pattern, the associated calendaring roller has a pattern of spiral grooves.

FIG. 10 depicts a fifth insulating sheet 70 in which a first major surface 71 has a first plurality of ribs 72 extending diagonally in one direction and a second plurality of ribs 73 extending diagonally in another direction, transverse to the direction of the first plurality of ribs 72. Therefore, both pluralities of ribs 72 and 73 extend at acute angles to the edges of the first major surface 71. Furthermore, the opposing second major surface 74 can also have a rib pattern thereon.

With reference to FIG. 11, a sixth insulating sheet 75 has a first major surface 77 with a first plurality of ribs 78 extending across the width of the sheet. A second plurality of ribs 79 projects outward, lengthwise from the first major surface, thereby forming a rectangular matrix of ribs. It should be understood that the opposite second major surface 76 optionally may have a rib pattern that is similar to or dissimilar from the rib pattern on the first major surface 77.

FIG. 12 illustrates a seventh insulating sheet 80 fabricated by an alternative process to the calendaring process in FIG. 6. Specifically, the seventh insulating sheet 80 has a major surface 82 on which a plurality of fibers 84 have been bonded to form individual ribs. for example, glass reinforced fibers may be glued or otherwise attached to a flat sheet body. Although the seventh insulating sheet 80 shows the fibers extending parallel to each other across the width of the sheet, other patterns can be employed, such as those shown previously for the calendared rib embodiments.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A transformer comprising:
a core of magnetic permeable material;
a first coil extending around the core;
a second coil extending around the core;
electrical insulation located either between the first coil and the core or between the first and second coil, the electrical insulation comprising a sheet of material that is non-conductive to electricity, the sheet having a first major surface and a second major surface opposing each other, and having a first plurality of ribs projecting outward from the first major surface.

2. The transformer as recited in claim 1 wherein the first plurality of ribs have a resiliency wherein the first plurality of ribs deform to absorb a force applied to the electrical insulation by one of the first and second coils.

3. The transformer as recited in claim 1 wherein the material is paper.

4. The transformer as recited in claim 1 wherein the material is an aromatic polyamide polymer.

5. The transformer as recited in claim 1 wherein the first plurality of ribs are parallel to each other.

6. The transformer as recited in claim 1 wherein the first plurality of ribs are spaced apart at regular intervals.

7. The transformer as recited in claim 1 wherein the first surface has a first edge and a second edge and the first plurality of ribs extend from the first edge to the second edge.

8. The transformer as recited in claim 1 further comprising a second plurality of ribs projecting outward from the first major surface and intersecting the first plurality of ribs.

9. The transformer as recited in claim 8 wherein the second plurality of ribs are parallel to each other.

10. The transformer as recited in claim 8 wherein the second plurality of ribs are spaced apart at regular intervals.

11. The transformer as recited in claim 1 wherein the first surface has a first edge and the first plurality of ribs extend perpendicular to the first edge.

12. The transformer as recited in claim 11 wherein the first surface has a second edge and further comprising a second plurality of ribs extending perpendicular to the second edge and intersecting the first plurality of ribs.

13. The transformer as recited in claim 1 wherein the first surface has a first edge and the first plurality of ribs extend at an acute angle to the first edge.

14. The transformer as recited in claim 13 wherein the first surface has a second edge and further comprising a second plurality of ribs extending at an acute angle to the second edge and intersecting the first plurality of ribs.

15. The transformer as recited in claim 1 wherein the sheet further comprises a second plurality of ribs projecting outward from the second major surface.

16. The transformer as recited in claim 15 further comprising a third plurality of ribs projecting outward from at least one of the first major surface and the second major surface and transverse to the first plurality of ribs and the second plurality of ribs.

17. The transformer as recited in claim 16 wherein the first, second and third pluralities of ribs extend perpendicular to edges of the first and second surfaces.

18. The transformer as recited in claim 16 wherein the first, second and third pluralities of ribs extend at acute angles to edges of the first and second surfaces.

19. The transformer as recited in claim 1 wherein the a first plurality of ribs plurality of ribs are produced by calendaring the sheet of material.

20. The transformer as recited in claim 1 wherein the a first plurality of ribs plurality of ribs are produced by bonding fibers to the first surface of the sheet.

21. A electrical insulator comprising a sheet of material that is non-conductive to electricity, the sheet having a first major surface and a second major surface opposing each other, and having a first plurality of ribs projecting outward from the first major surface.

22. The electrical insulator as recited in claim 21 wherein the material is paper.

23. The electrical insulator as recited in claim 21 wherein the material is an aromatic polyamide polymer.

24. The electrical insulator as recited in claim 21 wherein the first plurality of ribs are parallel to each other.

25. The electrical insulator as recited in claim 21 wherein the first plurality of ribs are spaced apart at regular intervals.

26. The electrical insulator as recited in claim 21 wherein the first surface has a first edge and the first plurality of ribs extend perpendicular to first edge.

27. The electrical insulator as recited in claim 21 wherein the first surface has a first edge and the first plurality of ribs extend at an acute angle to first edge.

28. The electrical insulator as recited in claim 21 further comprising a second plurality of ribs projecting outward from the first major surface and intersecting the first plurality of ribs.

29. The transformer as recited in claim 28 wherein the first plurality of ribs intersect the second plurality of ribs at substantially a right angle.

30. The transformer as recited in claim 28 wherein the first plurality of ribs intersect the second plurality of ribs at an acute angle.
